(19) United States
(12) Patent Application Publication
(10) Pub. No.: US 2011/0283528 A1
(43) Pub. Date: Nov. 24, 2011

(54) APPARATUS AND METHOD FOR DIRECTING HEAT

(76) Inventor: Donald Spinner, North Syracuse, NY (US)

(21) Appl. No.: 12/785,214

(22) Filed: May 21, 2010

(51) Int. Cl. B23P 15/26

(52) U.S. Cl. 29/726

(57) ABSTRACT

There is set forth herein a method including providing an apparatus adapted for reflection of heat, the providing including providing the apparatus to include a reflective assembly having a material member defining a front face, the material member being light transmissive and heat resistant, wherein the providing includes providing the reflective assembly to carry first indicia, the first indicia being viewable by viewing a front face of the reflective assembly, disposing the reflective assembly in an interior of a fireplace rearward of where there is to be initiated a fire in such manner that when a fire is initiated the reflective assembly directs heat and light from the interior of the fireplace to an exterior of the fireplace.

### FIELD OF THE INVENTION

The invention relates to indicia carrying apparatus in general and in particular to an indicia carrying apparatus that directs light and heat.

### BACKGROUND OF THE PRIOR ART

A number of varieties of fireplaces are known. A fireplace can include an opening and a plurality of walls defining a firebox. An interior floor of a fireplace is often referred to as a hearth while an exterior floor of a fireplace can be referred to as an outer hearth.

In a wood burning fireplace a grate can be disposed above the inner hearth. Firewood can be placed on the grate and ignited. Ventilation for a wood burning fireplace can be provided by a chimney. In a wood burning fireplace air from a room being heated by the fireplace is utilized for combustion.

In a gas fireplace a gas pipe can be routed to a location above the inner hearth. Gas from the gas pipe can be ignited for producing fire. Synthetic wood can be disposed in adjacent relation to the gas pipe which has the appearance of wood when the gas is ignited. In a gas burning fireplace ventilation can be provided by a chimney or a ventilation system which routes air from an exterior of a building for combustion.

Other apparatus and environments for support of fire include stoves, open hearths, campfires, fire pits, charcoal grills, and gas grills.

### SUMMARY OF THE INVENTION

There is set forth herein a method including providing an apparatus adapted for reflection of heat, the providing including providing the apparatus to include a reflective assembly having a material member defining a front face, the material member being light transmissive and heat resistant, wherein the providing includes providing the reflective assembly to carry first indicia, the first indicia being viewable by viewing a front face of the reflective assembly, disposing the reflective assembly in an interior of a fireplace rearward of where there is to be initiated a fire in such manner that when a fire is initiated the reflective assembly directs heat and light from the interior of the fireplace to an exterior of the fireplace.

There is provided an apparatus for use in directing heat and light from a fire. The apparatus in addition to directing heat and light from a fire can be provided to carry indicia. In one embodiment, the apparatus can include a reflective assembly that carries indicia. The indicia can be fixedly or replaceably carried. In one embodiment the indicia can be provided on a template. In one embodiment, a reflective assembly can be adapted to replaceably carry at least one template. In one embodiment, the apparatus can include a first template replaceably holdable by the reflective assembly and a second template replaceably holdable by the reflective assembly. The apparatus can be adapted so that the reflective assembly can hold at least one of the first template and the second template at a given time. There is set forth herein a method comprising providing an apparatus as set forth herein and disposing the apparatus in an invention of a fireplace so that heat and light from a fire within the fireplace invention are directed to an exterior of the fireplace.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, wherein like numerals are used to indicate like parts throughout the various views,

FIG. 1 is a perspective view of an apparatus in one embodiment in operation to direct heat from a fire;

FIG. 2 is a side view of a reflective assembly in one embodiment;

FIG. 3 is a side view of a reflective assembly in another embodiment;

FIG. 4 is a side view of a reflective assembly in another embodiment;

FIG. 5 is a front view of a reflective assembly carrying indicia comprising thermochromatic paint in a first state where the thermochromatic paint is below a threshold;

FIG. 6 is a front view of a reflective assembly carrying indicia comprising thermochromatic paint in a second state where the thermochromatic paint is above a threshold temperature;

FIG. 7 is a perspective view of a planar assembly in one embodiment;

FIG. 8 is an exemplary perspective view of a template in one embodiment where template can be fitted into a slot defined by a planar assembly;

FIG. 9 is an exemplary perspective view of a template in one embodiment where template can be fitted into a slot defined by a planar assembly;

FIG. 10 is an exemplary perspective view of a template in one embodiment where template can be fitted into a slot defined by a planar assembly;

FIG. 11 is a front view of a reflective assembly independently replaceably carrying a plurality of indicia by replaceably carrying the template of FIG. 9 and the template of FIG. 10 simultaneously;

FIG. 12 is a front view of a template in an embodiment wherein an indicia is defined by a void;

FIG. 13 is a front perspective view of a planar assembly adapted to replaceably hold a template in another embodiment;

FIG. 14 is a rear perspective view of the planar assembly of FIG. 13;

FIG. 15 and FIG. 16 are front perspective views of templates for use with a planar assembly as shown in the embodiment of FIG. 13 and FIG. 14;

FIG. 17 is an embodiment of an apparatus having multiple reflective assemblies;

FIG. 18 is a perspective view of a system having an apparatus including a forwardly moveable reflective assembly in a first state;

FIG. 19 is a perspective view of a system having an apparatus including a forwardly moveable reflective assembly in a second state;

FIG. 20 is a perspective view of a system having an apparatus including a forwardly moveable reflective assembly in a first state;

FIG. 21 is a front cross sectional view of the apparatus as shown in FIG. 20;

FIG. 22 is a block diagram illustrating an apparatus having a sensing unit and an external unit.

### DETAILED DESCRIPTION OF THE INVENTION

There is set forth herein a method comprising providing an apparatus adapted for reflection of heat, the providing including providing the apparatus to include a reflective assembly having a material member defining a front face, the material member being light transmissive and heat resistant, wherein the providing includes providing the reflective assembly to carry first indicia, the first indicia being viewable by viewing a front face of the reflective assembly; disposing the reflective assembly in an interior of a fireplace rearward of where there is to be initiated a fire in such manner that when a fire is initiated the reflective assembly directs heat and light from the interior of the fireplace to an exterior of the fireplace.

There is provided an apparatus for use in directing heat and light from a fire. The apparatus in addition to directing heat and light from a fire can be provided to carry indicia.

In one embodiment, the apparatus can include a reflective assembly that carries indicia. The indicia can be fixedly or replaceably carried. In one embodiment, the indicia can be provided on a template. In one embodiment, a reflective assembly can be adapted to replaceably carry at least one template. In one embodiment, the apparatus can include a first template replaceably holdable by the reflective assembly and a second template replaceably holdable by the reflective assembly. The apparatus can be adapted so that the reflective assembly can hold at least one of the first template and the second template at a given time. There is set forth herein a method comprising providing an apparatus as set forth herein and disposing the apparatus in an invention of a fireplace so that heat and light from a fire within the fireplace invention are directed to an exterior of the fireplace.

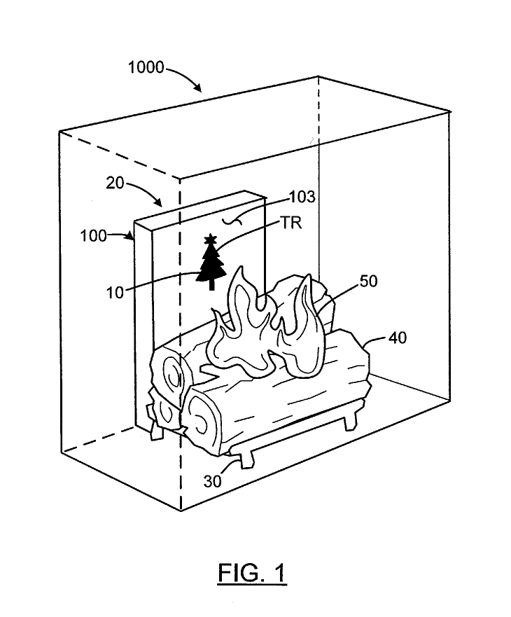

With reference to FIG. 1 there is shown an apparatus 20 for use in directing heat from a fire 50. In addition to directing heat from fire 50, apparatus 20 can direct light from fire 50 at a fire location and can carry indicia 10. In the development of apparatus 20 it was determined that a visual impact of an indicia 10 can be enhanced by disposal of the indicia on an apparatus 20 as set forth herein and by disposal of the resulting apparatus in a manner as set forth herein. In the embodiment of FIG. 1, fire 50 shown at a fire location is located within a three dimensional volume 1000. In one embodiment three dimensional volume 1000 can represent an interior of a fireplace. Volume 1000 in addition to representing an interior of a fireplace can also represent another apparatus or embodiment for support of a fire, e.g., stoves, open hearths, campfires, fire pits, charcoal grills, and gas grills. Fire 50 in the embodiment of FIG. 1 extends from logs 40. Logs 40 which can be disposed on grate 30 can be real logs or simulated logs, as in a gas fireplace. Where logs are real logs, fire 50 can be emitted from logs 40 during burning of the logs. Where the logs are simulated logs of a gas fireplace, fire 50 can be emitted from a gas pipeline (not shown) adjacent to the logs 40.

Referring to aspects of apparatus 20, apparatus 20 can be heat resistant, heat reflective, light reflective and can be adapted to carry indicia such as indicia 10. In one embodiment, apparatus 20 can include a reflective assembly 100. Reflective assembly 100 can carry indicia. Reflective assembly 100 can fixedly carry indicia and in one embodiment can replaceably carry indicia. In one embodiment, the reflective assembly 100 can be configured so that at least first and second replaceable templates are replaceably carried by the reflective assembly.

Reflective assembly 100 can carry indicia. For example in the case of FIG. 1, reflective assembly 100 carries indicia 10 in the form of a Christmas tree as shown in FIG. 1. In one embodiment, reflective assembly 100 can fixedly carry indicia. In one embodiment, reflective assembly 100 can replaceably carry indicia. In such embodiment, as will be set forth herein, indicia 10 can be provided on a replaceably carried template. Indicia 10 can comprise a variety of different information messages. In one embodiment, the indicia 10 can present calendar information, i.e., can present to a user information respecting the time of year. A Christmas tree can be regarded as calendar information, as it indicates a certain time of year. Other indicia in the form of holiday symbols, e.g., pumpkins (Halloween), turkey (Thanksgiving), Christmas trees, bells, candy canes (Christmas), a heart (Valentine's Day), and a shamrock (St. Patrick's Day) can also be regarded as calendar information.

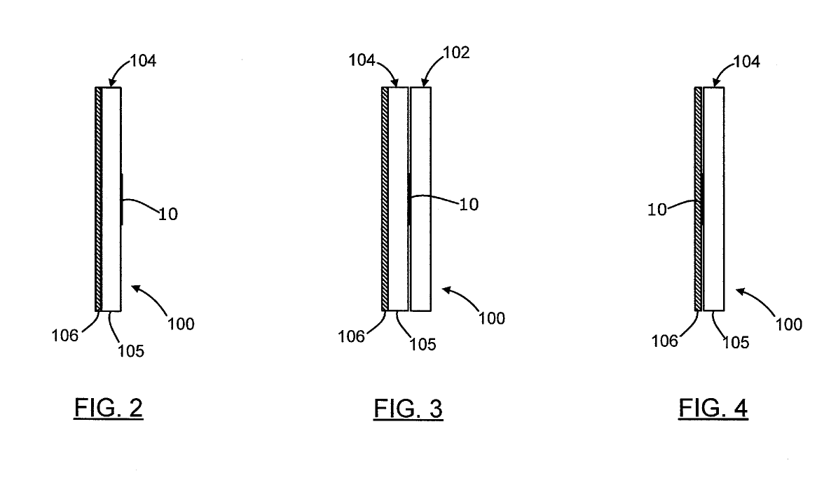

Referring to reflective assembly 100, reflective assembly 100 can include a number of possible constructions. FIGS. 2-4 show various embodiments of a reflective assembly 100 fixedly carrying indicia 10. In the embodiment of FIG. 2, reflective assembly 100 can include a heat resistant mirror 104 having a substrate 105 and reflective backing 106. In the embodiment of FIG. 2, indicia 10 can be disposed at an outer surface of mirror 104. In the embodiment of FIG. 3, reflective assembly 100 can include a mirror 104 having a substrate 105 and reflective backing 106. Mirror 104 in the embodiment of FIG. 3 can be heat resistant or non-heat resistant. Assembly 100 of FIG. 3 can also include light transmissive panel 102 disposed forward of mirror 104. Panel 102 can be regarded as a forward panel. Forward panel 102 can be light transmissive and heat resistant.

In the embodiment of FIG. 3, indicia 10 can be disposed between mirror 104 and panel 102. In the embodiment of FIG. 4, reflective assembly 100 can be provided by heat resistant mirror 104 having a substrate 105 and reflective backing 106. In the embodiment of FIG. 4, indicia 10 can be disposed between reflective backing 106 and the substrate 105 portion of mirror 104 forward of light reflective backing 106. Reflective assembly 100 can be provided in a substantially planar form as set forth in the figures herein. Reflective assembly 100 can have a front face 103 which can be substantively planar. A front face of assembly 100 can be defined by the most forward material member of assembly 100, e.g., mirror substrate member 105 in the case of FIGS. 2 and 4, forward panel member 102 in the case of FIG. 3. A most forward member defining front face 103 can be of unitary construction.

It will be seen that indicia 10 can be disposed forwardly or rearwardly of a member defining a front face 103 of reflective assembly 100. In either case the reflective assembly can be adapted so that the indicia can be viewed by viewing of the front face 103. For example, as set forth herein, the front face 103 can be defined by light transmissive material which will allow viewing of the indicia through the member defining the front face 103 even if the indicia 10 is disposed rearward of the member defining the front face.

For utilization of apparatus 20 reflective assembly 100 can be disposed rearward of the indicated fire location where there is to be initiated a fire in such manner that heat and light are directed from an interior of a fireplace to an exterior of a fireplace at a time when a fire is initiated. Where volume 1000 is shown in FIG. 1 represents a fireplace, an exterior of the fireplace can be the area in the foreground of volume 1000 as depicted in FIG. 1.

Regarding examples of indicia described herein, indicia 10 can be provided a plurality of different materials, e.g., metal, paint, plastic, ceramic, textiles, paper, magnets, ink Material forming indicia 10 can include heat resistant coatings. It can be particularly useful to apply such coatings where indicia 10 is disposed forward of a front face 103 or where indicia 10 otherwise will be subject to temperature approaching (e.g., within 400 degrees C./752 degrees F.) of a temperature of a visible flame (flame becomes visible at a temperature of about 525 degrees C./977 degrees F.). Heat resistant coatings which can partially or entirely define an indicia 10 of apparatus 20 can include the following coatings: Hi-Temp 707, Hi-Temp 400, Hi Temp 500V, Hi-Temp 500VS, Hi-Temp 500V HA, Hi-Temp 600ZN, Hi-Temp 1000V, Hi-Temp 1000VS, Hi-Temp 1000V HA, Hi-Temp 1027 (CUI, Stainless, Primer, DTR, Cryogenic), and Hi-Temp 1050 ZN. The noted high temperature heat resistant coatings are available from HI-TEMP COATINGS of Acton, Mass.

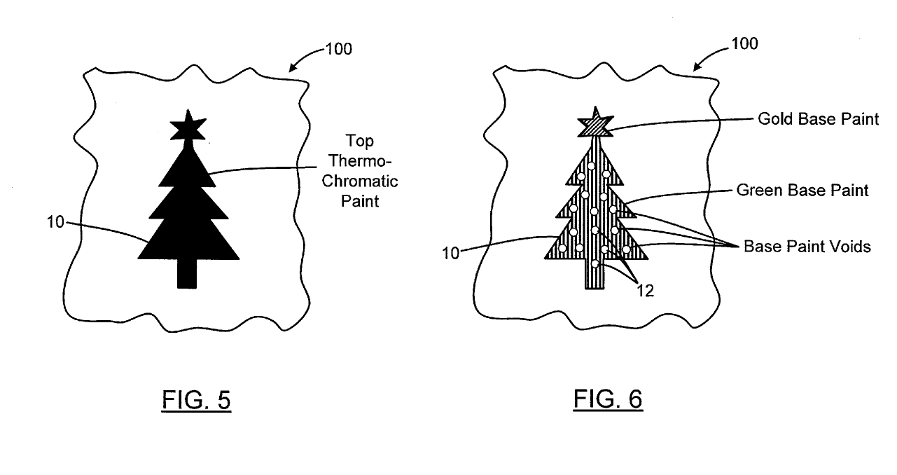

In one example, indicia 10 as set forth herein can comprise thermochromatic material, which can change an exhibited color with an increase in heat. In one example, the thermochromatic material can comprise thermochromatic paint. In one embodiment, thermochromatic paint for use in forming indicia herein can comprise liquid crystals capable of displaying different colors at different temperatures. In one embodiment, thermochromatic paint for use in forming indicia as set forth herein can include thermochromatic dyes. In one embodiment, thermochromatic paint can include both liquid crystals and thermochromatic dyes. In one embodiment, indicia 10 comprises thermochromatic material. Thermochromatic material forming indicia 10 can exhibit a color e.g., black, orange, or blue below a threshold temperature, and can become clear (colorless) above a threshold temperature. A thermochromatic paint in one embodiment can become clear at a threshold high temperature (e.g., 30 degrees C. (86 degrees F.)) so that at higher temperatures above a threshold, a color of material below the thermochromatic material is revealed. In one embodiment, indicia 10 can be provided by thermochromatic paint material that becomes clear above a threshold high temperature without an underlying layer of non-thermochromatic paint (in such embodiment, a reflective surface can be exposed when the thermochromatic material becomes clear). In one embodiment, indicia 10 comprises an under layer and an over layer of paint, the under layer being non-thermochromatic and the over layer being thermochromatic. Such embodiment is described with reference to FIGS. 5 and 6. In the embodiment of FIG. 5, there is shown a multi-layer indicia in a state where a temperature is below a threshold. The over layer exhibits a color in the view of FIG. 5. The below threshold temperature exhibited can be, e.g., black, blue, or orange. In the view of FIG. 6, the over layer is clear as a result of a temperature exceeding a threshold layer temperature (e.g., 30 degrees C./86 degrees F.). As a result of the over layer being in a clear state, under layer colors are exhibited. The under layer can comprise a combination of gold (for the stars) any green (for the tree) of the tree indicia. Further, voids 12 can be formed in the indicia. In the voids 12, where indicia 10 is disposed on a reflective assembly 100, the reflective surface of mirror 104 will reflect light to have the appearance of lights of a Christmas tree in the specific example. An example of commercially available thermochromatic paint is TEMPERATURE CHANGE PAINT available from PAINT WITH PEARL of Denver, Colo. By the described construction, an appearance of an indicia 10 can change after a fire is initiated.

Thermochromatic paint can usefully indicate a temperature of a reflective assembly 100. For example, in embodiments herein having replaceable reflective assemblies or replaceable templates, it may be advantageous to manually touch reflective assembly 100, e.g. for use in changing out a reflective assembly or a template thereof. Where an indicia comprises a paint that exhibits a certain color only when a temperature is below a predetermined threshold which is a safe temperature, the exhibiting of the certain color can usefully indicate a safe-to-touch condition. The thermochromatic paints described thus far can change from a color exhibiting state to a clear state. Indicia 10 or assembly 100 can also be defined with use of thermochromatic paint that exhibits a continuously changing array of colors at different temperatures. Thermochromatic paints defining indicias for use with apparatus 20 can include thermochromatic paints described in Design Concepts for a Temperature-sensitive Environment Using Thermochromic Colour Change, by Robert M. Christie, Sara Robertson, and Sarah Taylor, School of Textiles & Design, Heriot Watt University, Scottish Borders Campus, Galashiels TD13HF, UK, incorporated herein by reference. Forming indicia 10 with use of such continuously changing thermochromatic paint can increase an aesthetic effect of a displayed indicia. There is set forth herein a method including providing an apparatus according to an embodiment herein, wherein the providing includes providing the first indicia to be replaceable, wherein the providing includes providing the first indicia utilizing thermochromatic material, wherein the method includes observing the thermochromatic material, and wherein the method includes touching the reflective assembly to replace the first indicia if the thermochromatic material indicates that the reflective assembly is safe to touch. There is set forth herein a method including providing an apparatus according to an embodiment herein, wherein the providing includes providing the reflective assembly to be replaceable, wherein the providing includes providing the first indicia utilizing thermochromatic material, wherein the method includes observing the thermochromatic material, and wherein the method includes touching the reflective assembly to replace the reflective assembly if the thermochromatic material indicates that the reflective assembly is safe to touch.

A threshold temperature at which a thermochromatic material changes color can be controlled by control of the composition of the material. A threshold temperature at which a thermochromatic paint material color can also be controlled by control of a construction of reflective assembly 100. For example, for establishing a desired threshold temperature at which a thermochromatic material can change color, a thermochromatic material forming indicia 10 can be disposed rearward of a front face defining member, e.g., forward panel 102 of substrate 105, and the front face defining member can be provided to have a certain thickness and/or certain thermal resistivity so as to increase the threshold temperature to a certain desired temperature from a temperature which would be exhibited if the thermochromatic paint were provided forwardly of forward panel 102. Accordingly, a threshold temperature of indicia 10 can be increased from about 30 degrees C. (86 degrees F.) to any selected desired threshold, e.g., 149 degrees C. (300 degrees F.) by disposing the indicia rearward of an appropriately designed and selected front face defining member, e.g., forward panel 102 or substrate 105. A front face defining member can be of unitary construction.

It will be seen that any embodiment of an indicia herein, including embodiments including replaceable indicia can comprise thermochromatic material.

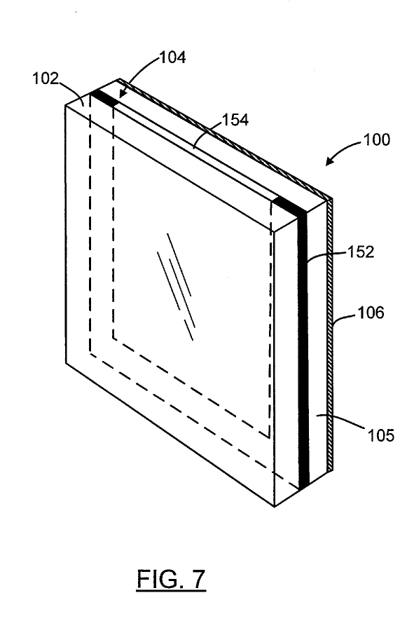

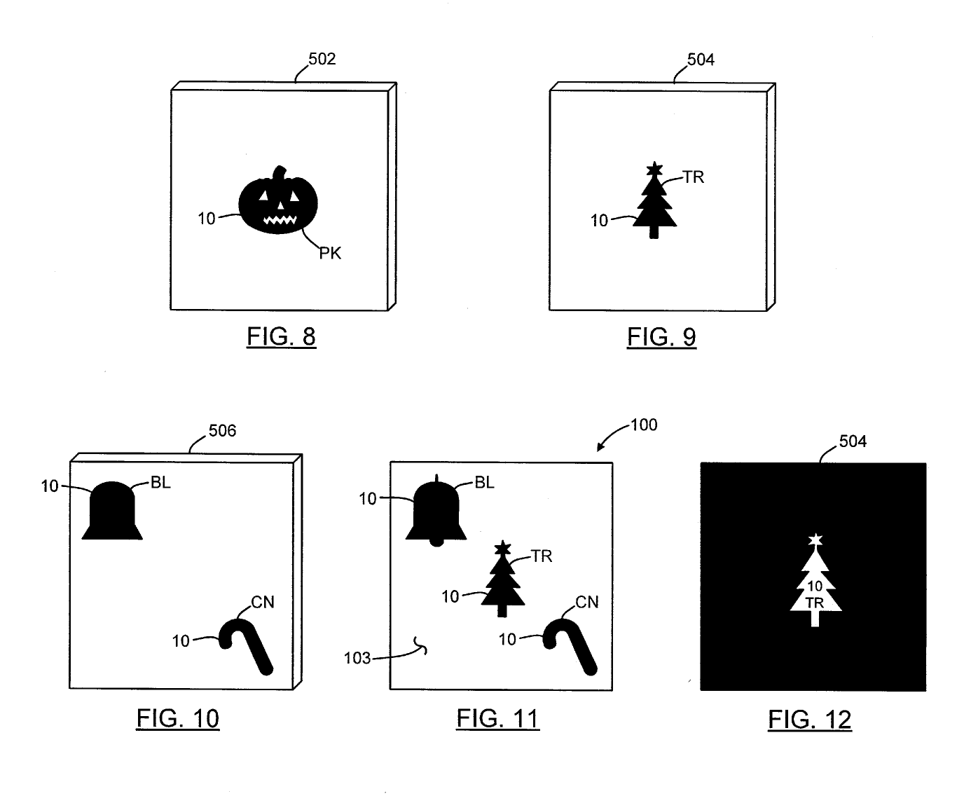

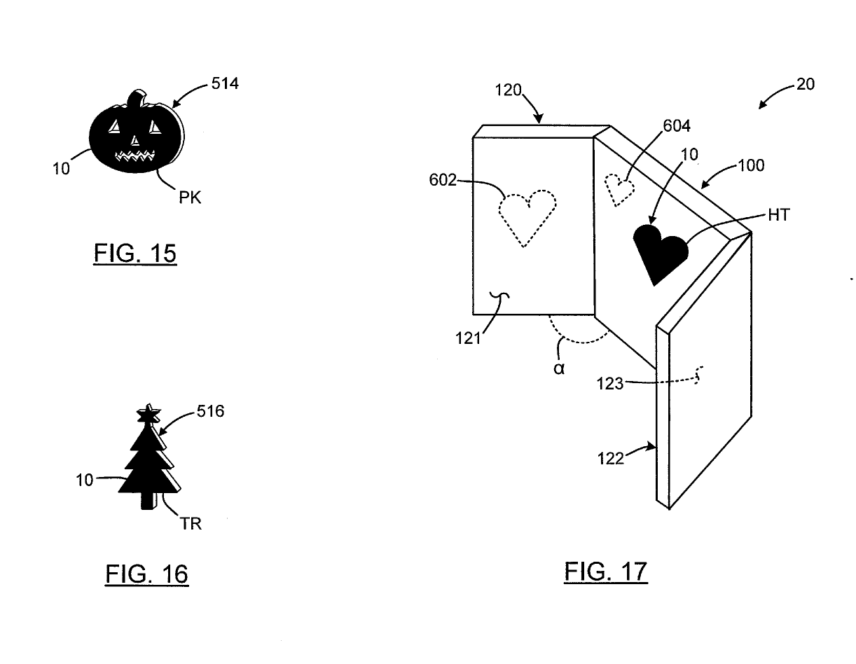

Another embodiment of reflective assembly 100 is described with reference to FIG. 7. Reflective assembly 100 can comprise a forward panel 102 and mirror 104. A peripheral spacer 152 can be disposed intermediate the forward panel 102 and mirror 104 so that there is defined between forward panel 102 and mirror 104, a slot 154. Forward panel 102 in one embodiment can comprise heat resistant glass. Mirror 104 in one embodiment can be provided by a standardly known mirror comprising a light transmissive substrate 105, e.g., comprising glass, with a reflective backing 106. Mirror 104 could also be provided by a reflective sheet of metal. Slot 154 can be sized and shaped to replaceably carry various templates. Examples of templates that can be carried in slot 154 are shown in FIGS. 8 and 9. In the example of FIG. 8, template 502 includes indicia 10 in the form of a pumpkin at location “PK.” In the example of FIG. 9, template 504 includes differentiated indicia 10 in the form of a tree at location “TR.” Templates 502 and 504 can comprise light transmissive material, e.g., glass extending outwardly from indicia 10 of templates 502 and 504 so as not to interfere with the reflective properties provided by mirror 104. Templates 502 and 504 can be light transmissive through a thickness thereof except on the area in which indicia, e.g., indicia 10 of template 502, indicia 10 of template 504 is disposed. In one embodiment, indicia 10 in the embodiment of FIGS. 8 and 9 can be provided by paint and can be provided by painting on the indicia with use of a stencil. Indicia 10 can be non-reflective and opaque. Accordingly, with one of template 502 or 504 inserted into slot 154, reflective assembly 100 in the embodiment as shown in FIG. 15 provides a planar assembly that is reflective (both heat and light reflective) throughout a front face thereof except in the area in which the indicia is located. Indicia 10 defined for use with insertable templates 502, 504 can also be reflective with reflectivity differentiated from a remainder of a face 103 of assembly 100.

In the views of FIGS. 8 and 9, templates 502, 504 include a single contiguous indicia. Templates herein can also include a plurality of contiguous indicia. In the view of FIG. 10, a template 506 is shown having a plurality of contiguous indicia; namely, indicia 10 at location “BL” in the form of a Bell, indicia 10 at location “CN” in the form of a cane. In one embodiment, slot 154 and templates for fitting into slots 154 can be adapted so that slot 154 can replaceably carry a maximum of one template at a given time. However, in another embodiment, slot 154, and templates 502, 504, 506 can be adapted so that slot 154 can replaceably carry a plurality of templates at a given time. In FIG. 11, there is shown a front view of assembly 100 with both template 504 and template 506 simultaneously fitted into slot 154. It is seen that with multiple templates fitted into slot 154, assembly 100 can simultaneously display indicias of more than one template, and that a user can customize a displayed design in accordance with a design desired by a user by selecting a particular arrangement or available templates.

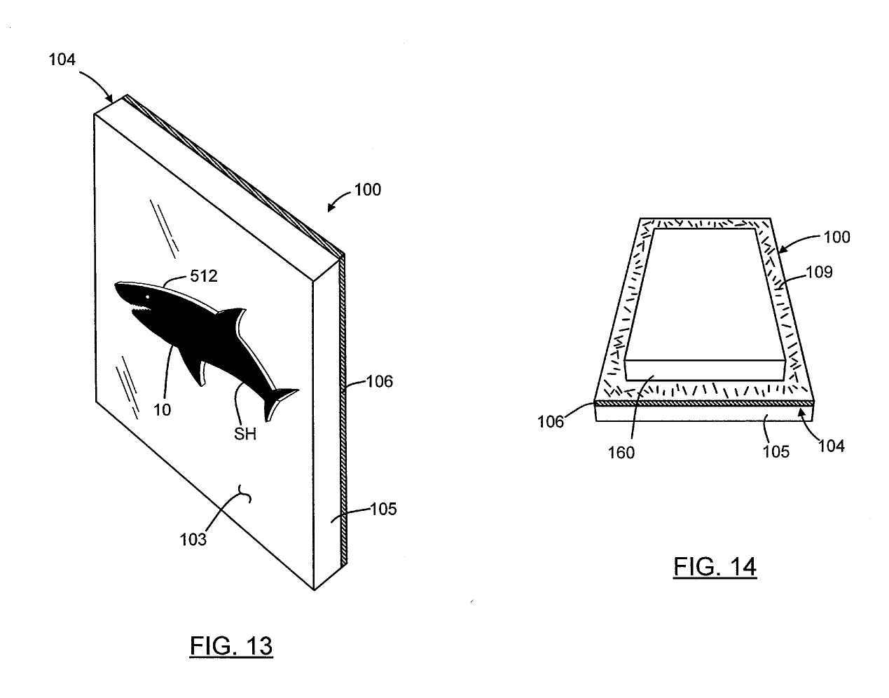

Another embodiment of reflective assembly 100 is shown and described with reference to FIGS. 13-16. In the embodiment of FIGS. 13 and 14, reflective assembly 100 can comprise a mirror 104 having a light transmissive (e.g., glass) substrate 105 and an associated reflective backing 106.

Referring to further aspects of the embodiment of FIGS. 13-16, reflective assembly 100 can include a magnetic coupler 160 for providing magnetic coupling with a template as can be provided with use in the embodiment according to FIGS. 13-16. Magnetic coupler 160 can be fixed to a back of mirror 104, e.g., with use of adhesives. Exemplary templates which can be used with the embodiment of FIGS. 9-15 include templates 512 (shown in FIG. 13 held on a front face of assembly 100), template 514 as shown in FIG. 15 and template 516 as shown in FIG. 16. In the embodiment of FIGS. 13-16 templates such as templates 512, 514, 516 can be replaceably held by reflective assembly 100 with use of magnetic coupling forces that can be provided by magnetic coupler 160. In one embodiment, magnetic coupler 160 is provided by a magnet and templates, e.g., templates 512, 514, 516 are provided by shaped articles of metal that are in magnetic coupling relation to magnetic coupler 160. In another embodiment, templates e.g., templates 512, 514, 516 can be provided by magnets and magnetic coupler 160 can be provided by a metal member in magnetic coupling relation to the magnet templates.

In the embodiment of FIGS. 13-16 indicia 10, e.g., shark indicia 10 shown at location “SH,” pumpkin indicia “PK,” and tree indicia “TR” can be defined by a shaping of a template. In the examples of templates 512, 514, 516 a peripheral shape of template defines the appearance of the indicia. Regarding templates 512, 514, 516 templates 512, 514, 516 can be heat resistant opaque and non-reflective. Templates 512, 514, 516 can also be reflective but differentiated reflectivity relative to a front face 103 of assembly 100 so that an appearance of template 512, 514, 516 can be readily discerned.

A template that can be associated to reflective assembly 100 can be switched out when desired by an operator for conveyance of differentiated message. Templates as have been described herein can have seasonal themes, e.g., a first template can include a pumpkin indicia associated to Halloween, a second template can include a turkey indicia associated to Thanksgiving, a third template can include a tree indicia associated to Christmas, a fourth template can include a heart indicia associated to Valentine's Day, a fifth template can include shamrock associated to St. Patrick's Day. An operator can replace the template associated to assembly based on the time of the calendar year so that the template presently held by assembly indicates a next upcoming or current season. In such manner, apparatus 20 provides a function of a calendar to continually indicate to an observer during steady state times at which the template is not being switched out a time of a calendar year.

In another aspect, indicia 10 of a template can include text characters, and the text characters can convey an information message selected by an operator. In one embodiment there are a set of 12 templates, each spelling out a different month of the calendar year. An operator can switch out a template each month so that apparatus 20 indicates a current month.

In another embodiment, a template can be provided with indicia that promotes and demonstrates an allegiance to a particular sports team. For example, the shark indicia of template 512 can in one embodiment be a shark logo for a particular sports team.

It can be particularly advantageous to include religious themed indicia, e.g., images of Jesus Christ, crosses, of the Christianity, the Wheel of Dharma of Buddhism, the Lotus Flower of Hinduism, the Star and Crescent of Islam, the Star of David of Judaism, the Yin & Yang of Taoism. Smoke and fire have an ethereal and mystical quality and can increase an impact of a religious themed indicia on an observer when apparatus 20 including an associated template with religious themes indicia is disposed in proximity of fire 50. Fire is regularly incorporated in a variety of religious ceremonies of a variety of different religions, e.g., Christianity, Judaism, Buddhism.

In addition to having an information conveyance effect it should also be emphasized that apparatus 20 has an advantageous heat and light transfer effect. Apparatus 20 in an operative position in relation to a fire 50 by disposing apparatus 20 so that it directs heat and light outwardly from a fireplace. Apparatus 20 can significantly increase an amount of heat and light that is output by a fireplace.

In embodiments of templates herein, indicia 10 has been shown as defined by opaque non-reflective material. In another embodiment, indicia 10 can be defined by an absence of opaque material, and a template can include a section of opaque material that includes a void defining the indicia. In the embodiment of FIG. 12, the template includes indicia 10 defined by an absence of indicia.

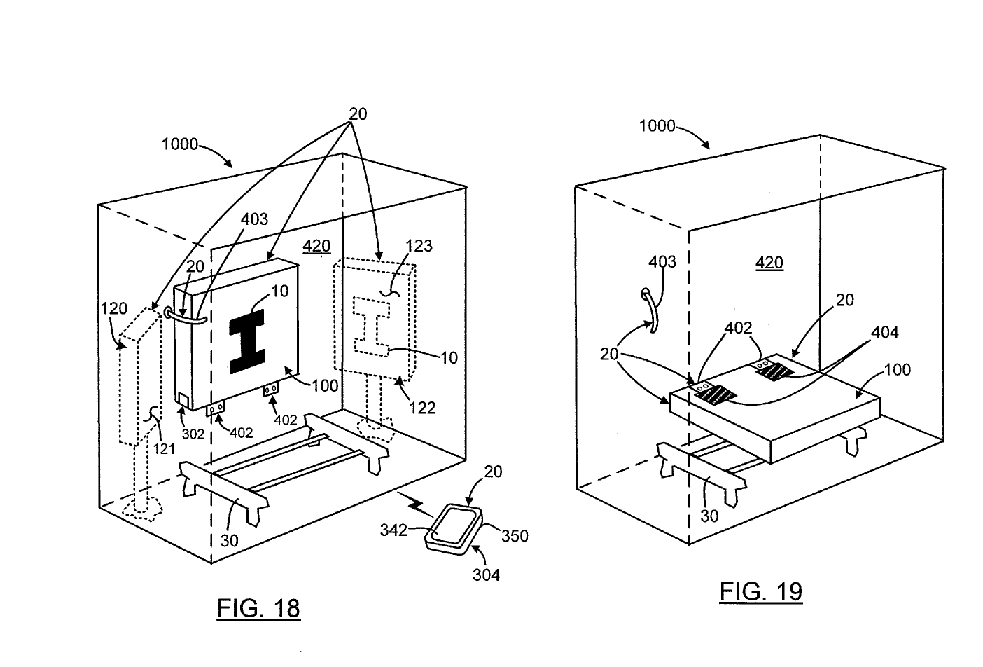

In the embodiment of FIG. 17, apparatus 20 is provided with first and second supplementary reflective assemblies 120 and 122. First supplementary reflective assembly 120 and second supplementary reflective assembly 122 can extend forwardly from assembly 100 which can be of any configuration suitable for holding of indicia 10 such as a heart indicia shown at location “HT” as set forth in the example of FIG. 17. First and second supplementary assemblies 120, 122 can be substantially planar in form. Assemblies 120, 122 can be constructed in accordance with any construction as described herein for reflective assembly 100 and can have disposed therein indicia 10 as described in relation to assembly 100. Assemblies 120, 122 can have substantially planar front faces. Assembly 120 can have a front face 121, which can be substantially planar and assembly 122 can have a front face 123, which can be substantially planar. Front faces 103, 121, 123 can be defined by material members, e.g., sheets of heat resistant, light transmissive material, e.g., heat resistant glass, which material members can be of uniform construction. In one embodiment, the apparatus 20 can be provided so that assemblies 100, 120, 122 are planar as indicated in FIGS. 17 and 18 and further so that assemblies 120, 122 extend angularly and forwardly from reflective assembly 100. In one embodiment, assemblies 120, 122 can define an obtuse angle, a, relative to assembly 100. In one embodiment, assemblies 120, 122, can be pivotally connected to reflective assembly 100 so that an angle between assembly 120 and assembly 100 and between assembly 122 and assembly 100 can be adjusted without disconnecting assemblies 120, 122 from assembly 100. In one embodiment, apparatus 20 can include a single one of assemblies 120, 122. Apparatus 20, in one embodiment, can have neither of supplementary assemblies 120, 122.

The “cradle” design as shown in FIGS. 17 and 18 can provide a number of advantages. The cradle design prevents significant amount of heat and light from escaping sidewardly from a fire 50 and therefore can play an important role in directing heat and light outwardly from a fireplace of which volume 100 can designate.

The cradle design as shown in FIG. 17 can also significantly increase an information conveyance capacity of apparatus 20. In the specific example of FIG. 17, apparatus 20 can include a single indicia 10; namely, the heart indicia at location “HT” which is held specifically by reflective assembly 100. However, at certain viewing angles, by way of the multiple reflecting surfaces reflecting and re-reflecting the image of the indicia, an image of the indicia may be visible to an observer at multiple locations. For example at a certain viewing angle an observer may observe an image of indicia 10 at location “HT,” at location 602, and also at a different size at location 604, notwithstanding apparatus 20 including a single instance of the indicia. The cradle design of FIG. 17 therefore can multiply the number of locations at which indicia can be observed by an operator. The multiple image effect can enhance an impact of an information conveyance by apparatus 20 in all applications including in application where there are multiple projections of a religious themed indicia. In the view of FIG. 17, assemblies 120, 122 are shown as being attached to reflective assembly 100. Assemblies 120, 122 can also be detached from reflective assembly 100 as shown in FIG. 18. There is set forth herein a method including providing an apparatus according to an embodiment herein, wherein the providing includes providing the apparatus to include a first supplemental reflective assembly, wherein the disposing includes disposing the first supplemental reflective assembly at an angle relative the first reflective assembly so that the first indicia carried by the reflective assembly can be viewed by viewing the first supplementary reflective assembly.

Referring to the embodiments of FIGS. 18 and 19, embodiments are described in which apparatus 20 is adapted so that reflective assembly 100 can be moved forwardly while a portion of apparatus 20 remains mounted within a fireplace.

In the embodiment of FIGS. 18 and 19, reflective assembly 100 is shown as being pivotably moveable. In the embodiment of FIGS. 18 and 19, an apparatus 20 can be provided to include a mount having hinges 402 and a latch 403 which can be mounted to a back wall 420 of a fireplace. Referring to the embodiments of FIGS. 18 and 19, reflective assembly 100 can be mounted on hinges 402 and can be moveable between a first position (FIG. 18) in which it is active and reflects heat and light from a fireplace to a second position (FIG. 19) at which reflective assembly 100 is moved forward to e.g., allow replacement of one or more templates as described here. For fixing of a first position latch 403 can be moved to a position as shown in FIG. 18. Latch 403 can be moved to the position shown in FIG. 19 to allow assembly 100 to drop by gravity forces into the second position in FIG. 19. Assembly 100 can be of a type as shown in FIG. 7 having a slot 154 for receipt of a template.

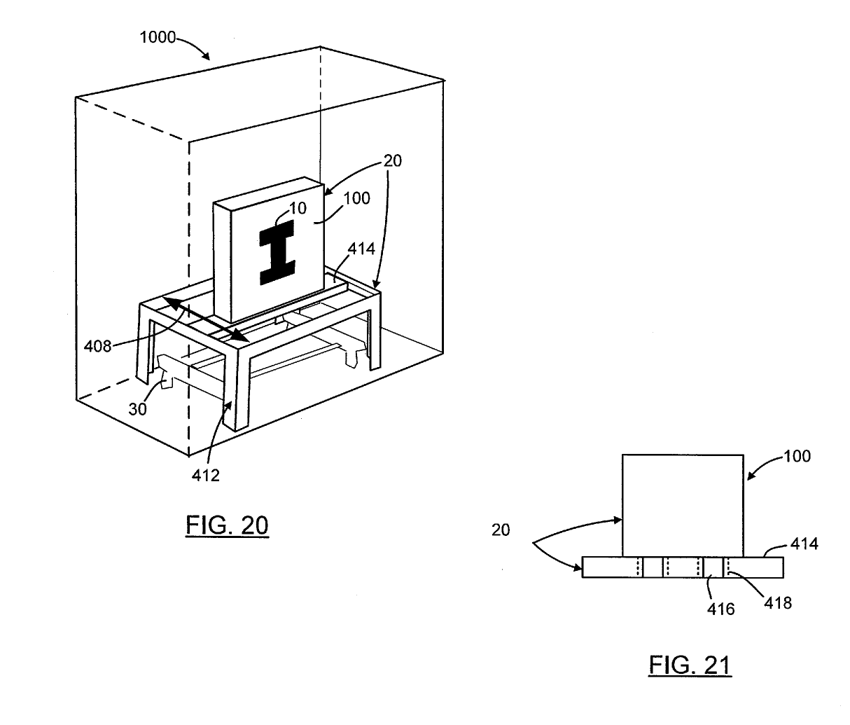

In the embodiment of FIG. 20, reflective assembly 100 is adapted to be slidably moveable in a forward and backward direction in the direction of arrow 408. In the embodiment of FIG. 20, apparatus 20 can include a frame 412 on which rack 414 supporting assembly 100 can be slideably disposed. In one aspect, assembly 100 can be mounted to rack 414 with hinges 402 so that assembly 100 can be both slideably and pivotably mounted. When reflective assembly 100 is moved to a forward position, slot 154 as seen in FIG. 7, is easily accessed to allow replacement of a template, e.g., template 502, 504, 506.

The embodiments as shown in FIGS. 18-20 are useful where assembly 100 is adapted to replaceably carry a replaceable template. However, in another embodiment, a function of replaceable indicia herein, in terms of allowing a displayed indicia to be varied, can be provided by configuring assembly 100 as a whole can be replaceable. Examples of embodiments where assembly 100 is replaceable are shown in FIGS. 19 and 20. In the view of FIG. 19, it is seen that a back of assembly 100 can be configured to include pockets 404 for frictionally and removably receiving hinges 402 which can be mounted to a back wall 420 of a fireplace. Assembly 100 can be removed by simply removing assembly 100 from the hinges and replacing with another assembly 100 carrying differentiated indicia. Differentiated indicia of various assemblies 100 herein can be differentiated in the same manner indicia of various templates as described herein. In the embodiment as shown in FIG. 21, assembly 100 in the view of FIG. 20 can include pegs 416 which are replaceably received in holes 418 of sliding rack 414. There is set forth herein a method including providing an apparatus according to an embodiment herein, wherein the providing includes providing the first indicia to be fixedly carried by the reflective assembly, wherein the providing further includes providing the apparatus to include a mount for replaceably receiving the reflective assembly, wherein the disposing includes disposing the reflective assembly utilizing the mount that replaceably receives the reflective assembly, and wherein the method further includes replacing the reflective assembly with a replacement reflective assembly that carries a second indicia different from the first indicia.

In various embodiments described herein, a reflective assembly 100 can have a plurality of different constructions, e.g., in one example can be provided by a mirror 104 carrying indicia on an external surface (e.g., FIG. 15) or can include a mirror 104 in combination with a forwardly disposed light transmissive panel (e.g., FIG. 3, FIG. 15). Where reflective assembly 100 includes a mirror 104 in combination with a forwardly disposed light transmissive panel, it can be convenient to provide the light transmissive panel to be heat resistant and to provide the mirror 104 to be in accordance with a standardly known house held vanity mirror.

Heat resistant light transmissive panels are available from a variety of sources. Table A illustrates specifics for an exemplary light transmissive panel that can be utilized. Heat resistant panels can be utilized for providing, e.g., forward panel 102, or a substrate 105 of a mirror 104 as set forth herein either of which can define a front face 103 of reflective assembly 100. The material member defining front face 103 of assembly 100 can be a light transmissive heat resistant material member having a maximum operating temperature in one embodiment of at least 150 degrees C. (302 degrees F.), and in one embodiment at least 200 degrees C. (392 degrees F.) and in one embodiment 300 degrees C. (572 degrees F.) and in one embodiment more that 400 degrees C. (752 degrees F.), and in one embodiment, more than 500 degrees C. (932 degrees F.). A glass member can be susceptible to thermal shock (commonly accompanied by cracking) if subject to temperatures of greater than its maximum operating temperature.

When mirror 104 is provided by a standardly known vanity mirror, the mirror can be provided by a glass substrate in combination with a standardly known mirror reflective backing 106.

TABLE A

| | |
|---|---|
| Manufacturer | Qinhuangdao Scinan Specialty |
| | Glass Company, Limited, |
| | Hebei, China |
| Product | Borosilicate fire resistant glass |
| Brand Name | Yaohua |
| Heat Conductivity | 1.2 W/mk |
| Thickness | 1.50 mm-8.00 mm |
| Color | Clear |
| Transmittance | 92% |
| Softening Point | 820° C. (1508° F.) |

Heat-resistant glass can be provided in a form that is more resistant to high temperatures than ordinary glass (normally referring to untempered soda-lime glass). In one embodiment, heat resistant glass can be provided by borosilicate glass. In another embodiment, heat resistant glass can be provided by glass, ceramic glass, or tempered soda-lime glass. Normal glass, normally referring to untempered soda-lime glass, can have a maximum operating temperature of about 110 degrees C. (230 degrees F.). Heat resistant glass can have a maximum operating temperature of 150 degrees C. or more (302 degrees F., or more). In one example, a heat resistant panel for use in providing forward panel 102 or substrate 105 of mirror 104 can be provided by a ceramic glass panel provided by KERAGLASS ceramic glass of the type available from EUROKERA. KERAGLASS ceramic glass can have a maximum operating temperature of at least 600 degrees C. (1112 degrees F.), e.g., up to about 700 degrees C. (1292 degrees F.).

Untempered soda lime glass has a high thermal expansion coefficient, which means that it expands at a high rate when subjected to heat. Such expansion can cause the glass to shatter, a consequence known as thermal shock. Glass can be made to resist thermal shock by changing its chemical composition, method of manufacture, or both.

Borosilicate glass is lighter and stronger than untempered soda-lime glass, has a higher melting point, and has a much lower thermal expansion coefficient. Glass ceramic is glass that has been heat treated until crystals begin to form in the glass. By varying the amount of crystal, it is possible to create heat resistant glass with a broad range of possible thermal expansion coefficients.

Tempered glass has been heat treated during manufacturing, causing the internal portion of the glass to contract and surface tension to increase, resulting in a better balancing of stresses in the glass. Tempered glass is stronger than untempered glass, and better resists thermal shock.

For making of a mirror, a mirror substrate (e.g., provided by heat resistant or non-heat resistant glass, e.g., untempered soda-lime glass) can be polished and cleaned, and then coated. To provide a backing, the backing can comprise a plurality of coatings. The plurality of coatings can include silver or tin. A chemical actuator can be applied for hardening the silver or tin. Paint can be added for environmental protection. Copper in some instances is added for long-term durability.

In some embodiments, mirror 104 can be provided by a heat resistant mirror. A commercially available material for providing a heat resistant mirror is summarized in Table B below. A heat resistant mirror can also be provided by utilizing a section of heat resistant glass as a substrate 105 of the mirror and then applying a reflective backing in a manner set forth herein.

TABLE B

| | |
|---|---|
| Manufacturer | präzisions glas & optik |
| Product | SIR-Dielectric Hot Mirror |
| Product Code | SIR Hot Mirror |
| Substrates | Temperature resistant borosilicate glass |
| Coating | 100% dielectric |
| Operating | Up to 400 degrees C. (752 degrees F.) |
| Temperature | |
| Flatness | Depends on substrate material and thickness |
| Surface Quality | Typ. 80-50 scratch & dig (MIML-0-13830A) |
| Standard | 1, 1 mm/1, 75 mm/3, 3 mm |
| Thickness | |
| Other | Adherence according to MIL-C-675 C tape test and |
| | abrasion resistant according to MIL-M-13508 C |

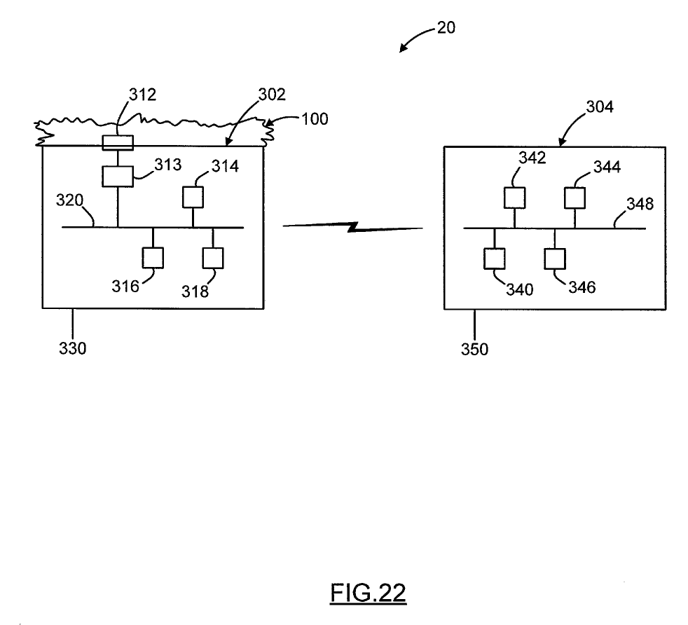

Referring to FIG. 18 and FIG. 22, apparatus 20 can have disposed on assembly 100 a sensing unit 302. Sensing unit 302 can be in communication with external unit 304. In the view of FIG. 18, external unit 304 is shown as being disposed at an exterior of a fireplace where volume 1000 is representative of a fireplace. In one embodiment, sensing unit 302 can be in communication with external unit 304 via communication interfaces 318 and 340 which can be wireless communication interfaces. Sensing unit 302, in one embodiment, can include a thermocouple 312 operatively disposed for sensing a temperature of assembly 100. Sensing unit 302 can also include CPU 314, memory 316, I/O interface 318, and system bus 320 as well as interface circuit 313. Interface circuit 313 can process signals generated by thermocouple 312 for presentation of the signals to system bus 320 for access and processing by CPU 314.

External unit 304 can include I/O interface 340, display 342, CPU 344, memory 346, and system bus 348. Sensing unit 302 can include heat resistant housing 330. External unit 304 can include hand held housing 350. External unit 304 can be hand held and portable and can be moveable between a plurality of locations relative to volume 1000, which can be e.g., a fireplace. Interface 318 and interface 340 can be wireline communication interfaces, e.g., Bluetooth communication interfaces. Interfaces 318 and 340 can also be wireline communication interfaces and external unit 350 can be wireline connected to sensing unit 302 connected for communication with sensing unit 302.

External unit 304 can be a custom unit retailed together with remaining elements of apparatus 20. External unit 304 can also be, e.g., a smart phone, e.g., an IPHONE by Apple retailed separately from remaining components and configured to include an application for supporting operation of apparatus 20.

In one embodiment, temperature indicating signals can be generated by thermocouple 312. Such signals can be processed by circuit 313 and can be further processed by CPU 314 and can be transmitted in the form of digital data to external unit 304. External unit 304 can be adapted to process the temperature indicating signals. Apparatus 10 can be configured so that responsively to the temperature indicating signals indicating a temperature below a predetermined “save to the touch” condition, external unit 304 can display on display 342 an indicator, e.g., a textural message stating that assembly 100 is safe to touch. After observing such indicator, an operator can touch assembly 100 to, e.g., replace an indicia 10 if assembly 100 includes a replaceable indicia, or replace reflective assembly 100 if apparatus 20 includes a replaceable reflective assembly 100. There is set forth herein a method including providing an apparatus according to an embodiment herein, wherein the providing includes providing the apparatus to include a sensing unit adapted to sense a condition of the reflective assembly, wherein the providing includes providing an external unit external to the sensing unit, the external unit being in communication with the sensing unit, wherein the method includes displaying on the external unit indicator information responsively to signal generated by the sensing unit.

A small sample of systems methods and apparatus that are described herein is as follows:

A1. A method comprising:

providing an apparatus adapted for reflection of heat, the providing including providing the apparatus to include a reflective assembly having a material member defining a front face, the material member being light transmissive and heat resistant, wherein the providing includes providing the reflective assembly to carry first indicia, the first indicia being viewable by viewing a front face of the reflective assembly;

disposing the reflective assembly in an interior of a fireplace rearward of where there is to be initiated a fire in such manner that when a fire is initiated the reflective assembly directs heat and light from the interior of the fireplace to an exterior of the fireplace.

A2. The method of A1, wherein the providing includes providing the apparatus so that the first indicia is disposed rearward of the front face.
A3. The method of A1, wherein the providing includes providing the first indicia utilizing thermochromatic material.
A4. The method of A1, wherein the providing includes providing the first indicia utilizing thermochromatic material that becomes optically clear when a threshold temperature is exceeded.
A5. The method of A1, wherein the providing includes providing the reflective assembly so that the first indicia is replaceable.
A6. The method of A1, wherein the providing includes providing the reflective assembly so that the first indicia is replaceable, and wherein the method further includes replacing the first indicia with a second indicia.
A7. The method of A1, wherein the providing includes providing the slot to replaceably carry a template, and wherein the providing includes providing the first indicia on a template replaceably carried in the slot.
A8. The method of A1, wherein the providing includes providing the first indicia to be replaceably carried by the reflective assembly, wherein the providing further includes providing a second indicia replaceably carried on the reflective assembly independently of the first indicia.
A9. The method of A1, wherein the providing includes providing the first indicia to be replaceable, and wherein the providing includes providing the first indicia to be in the form of a Thanksgiving symbol, wherein the method includes replacing the first indicia with a second indicia in the form of a Christmas symbol.
A10. The method of A1, wherein the providing includes providing the first indicia to be fixedly carried by the reflective assembly, wherein the providing further includes providing the apparatus to include a mount for replaceably receiving the reflective assembly, wherein the disposing includes disposing the reflective assembly utilizing the mount that replaceably receives the reflective assembly, and wherein the method further includes replacing the reflective assembly with a replacement reflective assembly that carries a second indicia different from the first indicia.
A11. The method of A1, wherein the providing includes providing the apparatus to include a first supplemental reflective assembly, wherein the disposing includes disposing the first supplemental reflective assembly at an angle relative the first reflective assembly so that the first indicia carried by the reflective assembly can be viewed by viewing the first supplementary reflective assembly.
A12. The method of A1, wherein the providing includes providing the first indicia utilizing thermochromatic material layered over an under layer, the thermochromatic paint having a threshold temperature at which it becomes clear, the method further comprising applying heat to the reflective assembly so that the under layer is revealed.
A13. The method of A1, wherein the providing includes providing the apparatus to include a sensing unit adapted to sense a condition of the reflective assembly, wherein the providing includes providing an external unit external to the sensing unit, the external unit being in communication with the sensing unit, wherein the method includes displaying on the external unit indicator information responsively to a signal generated by the sensing unit.
A14. The method of A1, wherein the providing includes providing the apparatus to include a sensing unit adapted to sense a temperature of the reflective assembly, wherein the providing includes providing an external unit external to the sensing unit, the external unit being in communication with the sensing unit, wherein the method includes displaying on the external unit indicator information responsively to a temperature indicating signal generated by the sensing unit.
A15. The method of A1, wherein the providing includes providing the apparatus to include a mount for mounting of the reflective assembly so that the reflective assembly can be moved forwardly while remaining mounted on the mount.
A16. The method of A1, wherein the providing includes providing the first indicia to be replaceable, and wherein the providing includes providing the first indicia to be in the form of a first holiday symbol, wherein the method includes replacing the first indicia with a second indicia in the form of a second holiday symbol different than the first holiday symbol.
A17. The method of A1, wherein the providing includes providing the first indicia to be replaceable, wherein the providing includes providing the first indicia utilizing thermochromatic material, wherein the method includes observing the thermochromatic material, and wherein the method includes touching the reflective assembly to replace the first indicia if the thermochromatic material indicates that the reflective assembly is safe to touch.
A18. The method of A1, wherein the providing includes providing the reflective assembly to be replaceable, wherein the providing includes providing the first indicia utilizing thermochromatic material, wherein the method includes observing the thermochromatic material, and wherein the method includes touching the reflective assembly to replace the reflective assembly if the thermochromatic material indicates that the reflective assembly is safe to touch.
A19. The method of A1, wherein the providing includes providing the reflective assembly to be replaceable, wherein the method includes replacing the reflective assembly with a second reflective assembly carrying a second indicia.
B1. An apparatus comprising:

a reflective assembly;

a first supplemental reflective assembly extending forwardly from the reflective assembly;

a second supplemental reflective assembly extending forwardly from the reflective assembly;

wherein the reflective assembly comprises:
a forward panel, the forward panel member being light transmissive and heat resistant;
a mirror having a substrate and a reflective backing, the mirror disposed rearward of the forward panel and defining with the forward panel a slot;
a first template replaceably fittable into the slot, the first template defining a first indicia;
a second template replaceably fittable into the slot, the second template defining a second indicia;

wherein the apparatus is adapted so that the slot replaceably carries at least one of the first and second templates at a given time.

B2. The apparatus of B1, wherein the first template comprises a light transmissive member carrying an opaque stencil.
B3. The apparatus of B1, wherein the first template has a theme selected from the group consisting of Halloween, Thanksgiving, Christmas, Valentine's Day, St. Patrick's Day, and the second template has a theme different from the first theme and also selected from the group consisting of Halloween, Thanksgiving, Christmas, Valentines Day, St. Patrick's Day.
B4. The apparatus of B1, wherein the first supplemental reflective assembly is adjustably attached to the reflective assembly so that the angle between the reflective assembly and the left end planar assembly can be adjusted.
B5. The apparatus of B1, wherein the first supplemental reflective assembly is adapted to extend forwardly and angularly from the reflective assembly so that from a top view the left end planar assembly forms an obtuse angle with the reflective assembly.
C1. An apparatus comprising:

a reflective assembly;

wherein the reflective assembly comprises:

a front face, the front face being defined by a material member that is light transmissive and heat resistant;

a reflective backing;

a first template replaceably holdable by the reflective assembly;

a second template replaceably holdable by the reflective assembly;

wherein the apparatus is adapted so that the reflective assembly can hold at least one of the first template and the second template at a given time.

C2. The apparatus of C1, wherein the apparatus is configured so that the first template is replaceably holdable with utilization of magnet forces.
C3. The apparatus of C2, wherein the apparatus includes a forward panel defining the front face and a substrate disposed rearward of forward panel, the substrate having disposed therein the reflective backing, wherein the apparatus is configured so that there is a slot defined between the forward panel and the substrate, and wherein the first template is replaceably holdable by the reflective assembly by being replaceably fittable into the slot.
C4. The apparatus of C1, wherein the reflective backing is disposed on said material member.
C5. The apparatus of C1, wherein the material member is a forward panel, and wherein there is disposed rearward of the forward panel a substrate, the substrate having disposed thereon the reflective backing.
D1. A method for utilizing a fireplace, the fireplace having a fire location, the method comprising:

providing a reflective assembly, wherein the providing includes providing the reflective assembly to be reflective and providing the reflective assembly in such form that the reflective assembly carries the indicia; and

positioning the reflective assembly within the fireplace rearward of the fire location, and at such location that light and heat is directed outwardly from the fireplace, and further so that the indicia carried by the reflective assembly is visible from an exterior of the fireplace.

D2. The method of D1, wherein the providing includes providing the indicia to be replaceably carried by the reflective assembly.
D3. The method of D1, wherein the providing includes providing the indicia utilizing thermochromatic material.
D4. The method of D1, wherein the providing includes providing a supplementary reflective assembly at such position to reflect an image of the indicia to a viewing location external to the fireplace.
D5. The method of D1, wherein the providing includes providing the indicia utilizing an under layer of non-thermochromatic material and an upper layer of thermochromatic material that becomes clear at temperatures exceeding a threshold, so that the lower layer becomes visible when a temperature exceeds the threshold.
D6. The method of D1, wherein the providing includes providing the indicia utilizing an under layer of non-thermochromatic material and an upper layer of thermochromatic material that becomes clear at temperatures exceeding a threshold, the under layer having a void to allow reflected light rays to pass, so that the lower layer becomes visible and further so that reflected light rays pass through the void when the a temperature exceeds the threshold.
D7. The method of D1, wherein the providing includes providing the indicia to be replaceably carried by the reflective assembly with use of a template fittable into a slot of the reflective assembly.
D8. The method of D1, wherein the providing includes providing the indicia to be replaceably carried by the reflective assembly with use of magnet forces.
D9. The method of D1, wherein the providing includes providing the indicia to be replaceably carried by the reflective assembly with use of a template fittable into a slot of the reflective assembly, the template having an indicia portion and a peripheral light transmissive portion.

While the present application has been described with reference to a number of specific embodiments, it will be understood that the true spirit and scope of the application should be determined only with respect to claims that can be supported by the present specification. Further, while in numerous cases herein wherein systems and apparatuses and methods are described as having a certain number of elements it will be understood that such systems, apparatuses and methods can be practiced with fewer than or more than the mentioned certain number of elements. Also, while a number of particular embodiments have been set forth, it will be understood that features and aspects that have been described with reference to each particular embodiment can be used with each remaining particularly set forth embodiment.

We claim:

1. A method comprising:
providing an apparatus adapted for reflection of heat, the providing including providing the apparatus to include a reflective assembly having a material member defining a front face, the material member being light transmissive and heat resistant, wherein the providing includes providing the reflective assembly to carry first indicia, the first indicia being viewable by viewing a front face of the reflective assembly;
disposing the reflective assembly in an interior of a fireplace rearward of where there is to be initiated a fire in such manner that when a fire is initiated the reflective assembly directs heat and light from the interior of the fireplace to an exterior of the fireplace.

2. The method of claim 1, wherein the providing includes providing the apparatus so that the first indicia is disposed rearward of the front face.

3. The method of claim 1, wherein the providing includes providing the first indicia utilizing thermochromatic material.

4. The method of claim 1, wherein the providing includes providing the first indicia utilizing thermochromatic material that becomes optically clear when a threshold temperature is exceeded.

5. The method of claim 1, wherein the providing includes providing the reflective assembly so that the first indicia is replaceable.

6. The method of claim 1, wherein the providing includes providing the reflective assembly so that the first indicia is replaceable, and wherein the method further includes replacing the first indicia with a second indicia.

7. The method of claim 1, wherein the providing includes providing the slot to replaceably carry a template, and wherein the providing includes providing the first indicia on a template replaceably carried in the slot.

8. The method of claim 1, wherein the providing includes providing the first indicia to be replaceably carried by the reflective assembly, wherein the providing further includes providing a second indicia replaceably carried on the reflective assembly independently of the first indicia.

9. The method of claim 1, wherein the providing includes providing the first indicia to be replaceable, and wherein the providing includes providing the first indicia to be in the form of a Thanksgiving symbol, wherein the method includes replacing the first indicia with a second indicia in the form of a Christmas symbol.

10. The method of claim 1, wherein the providing includes providing the first indicia to be fixedly carried by the reflective assembly, wherein the providing further includes providing the apparatus to include a mount for replaceably receiving the reflective assembly, wherein the disposing includes disposing the reflective assembly utilizing the mount that replaceably receives the reflective assembly, and wherein the method further includes replacing the reflective assembly with a replacement reflective assembly that carries a second indicia different from the first indicia.

11. The method of claim 1, wherein the providing includes providing the apparatus to include a first supplemental reflective assembly, wherein the disposing includes disposing the first supplemental reflective assembly at an angle relative the first reflective assembly so that the first indicia carried by the reflective assembly can be viewed by viewing the first supplementary reflective assembly.

12. The method of claim 1, wherein the providing includes providing the first indicia utilizing thermochromatic material layered over an under layer, the thermochromatic paint having a threshold temperature at which it becomes clear, the method further comprising applying heat to the reflective assembly so that the under layer is revealed.

13. The method of claim 1, wherein the providing includes providing the apparatus to include a sensing unit adapted to sense a condition of the reflective assembly, wherein the providing includes providing an external unit external to the sensing unit, the external unit being in communication with the sensing unit, wherein the method includes displaying on the external unit indicator information responsively to a signal generated by the sensing unit.

14. The method of claim 1, wherein the providing includes providing the apparatus to include a sensing unit adapted to sense a temperature of the reflective assembly, wherein the providing includes providing an external unit external to the sensing unit, the external unit being in communication with the sensing unit, wherein the method includes displaying on the external unit indicator information responsively to a temperature indicating signal generated by the sensing unit.

15. The method of claim 1, wherein the providing includes providing the apparatus to include a mount for mounting of the reflective assembly so that the reflective assembly can be moved forwardly while remaining mounted on the mount.

16. The method of claim 1, wherein the providing includes providing the first indicia to be replaceable, and wherein the providing includes providing the first indicia to be in the form of a first holiday symbol, wherein the method includes replacing the first indicia with a second indicia in the form of a second holiday symbol different than the first holiday symbol.

17. The method of claim 1, wherein the providing includes providing the first indicia to be replaceable, wherein the providing includes providing the first indicia utilizing thermochromatic material, wherein the method includes observing the thermochromatic material, and wherein the method includes touching the reflective assembly to replace the first indicia if the thermochromatic material indicates that the reflective assembly is safe to touch.

18. The method of claim 1, wherein the providing includes providing the reflective assembly to be replaceable, wherein the providing includes providing the first indicia utilizing thermochromatic material, wherein the method includes observing the thermochromatic material, and wherein the method includes touching the reflective assembly to replace the reflective assembly if the thermochromatic material indicates that the reflective assembly is safe to touch.

19. The method of claim 1, wherein the providing includes providing the reflective assembly to be replaceable, wherein the method includes replacing the reflective assembly with a second reflective assembly carrying a second indicia.
